(19) United States
(12) Patent Application Publication
(10) Pub. No.: US 2025/0277069 A1
(43) Pub. Date: Sep. 4, 2025

(54) VINYL ESTER LATEX

(71) Applicants: Dow Global Technologies LLC, Midland, MI (US); Rohm and Haas Company, Collegeville, PA (US)

(72) Inventors: Matthew Carter, Bala Cynwyd, PA (US); Graham P. Abramo, Penllyn, PA (US); Ligeng Yin, Collegeville, PA (US); Robert David Grigg, Midland, MI (US); Meng Jing, Collegeville, PA (US); James Defelippis, Perkiomenville, PA (US); Scott Backer, Phoenixville, PA (US); Lyndsay M. Leal, Spring City, PA (US)

(21) Appl. No.: 18/857,200

(22) PCT Filed: May 22, 2023
(86) PCT No.: PCT/US2023/023035

§ 371 Date: Oct. 16, 2024

Related U.S. Application Data
(60) Provisional application No. 63/345,046, filed on May 24, 2022.

(51) Int. Cl. C08F 218/06; C11D 3/37

(52) U.S. Cl. CPC C08F 218/06; C11D 3/3753

(57) ABSTRACT

A vinyl ester latex is provided, comprising: 20-80 wt % structural units of monoethylenically unsaturated vinyl alkanoate: 20-80 wt % structural units of monoethylenically unsaturated carboxylic acid functionalized vinyl ester: 0-5 wt % structural units of multiethylenically unsaturated crosslinker: 0-20 wt % structural units of an other monoethylenically unsaturated monomer, wherein the other monoethylenically unsaturated monomer is different from the monoethylenically unsaturated vinyl alkanoate and the monoethylenically unsaturated carboxylic acid functionalized vinyl ester; wherein the vinyl ester latex contains <10 wt % structural units of monoethylenically unsaturated dicarboxylic acid having 4-6 carbon atoms, alkali metal salts thereof, ammonium salts thereof and mixtures thereof: wherein the vinyl ester latex contains <5 mol % structural units of anhydride of a dicarboxylic acid: wherein the vinyl ester latex contains <1.2 wt % structural units of 2-acrylamido-2-methyl-propanesulfonic acid; and wherein the vinyl ester latex contains <10) wt % structural units of monoethylenically unsaturated alkyl acrylate monomer containing 2-10 carbon atoms.

The present invention relates to a vinyl ester latex. In particular, the present invention relates to a vinyl ester latex, comprising: 20 to 80 wt %, based on dry weight of the vinyl ester latex, of structural units of a monoethylenically unsaturated vinyl alkanoate having 4 to 12 carbon atoms; 20 to 80 wt %, based on dry weight of the vinyl ester latex, of structural units of a monoethylenically unsaturated carboxylic acid functionalized vinyl ester having 4 to 12 carbon atoms; 0 to 5 wt %, based on dry weight of the vinyl ester latex, of structural units of a multiethylenically unsaturated crosslinker; 0 to 20 wt %, based on dry weight of the vinyl ester latex, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms; wherein the vinyl ester latex contains less than 1.2 wt %, based on dry weight of the vinyl ester latex, of structural units of 2-acrylamido-2-methyl-propanesulfonic acid; and wherein the vinyl ester latex contains less than 10 wt %, based on dry weight of the vinyl ester latex, of structural units of a monoethylenically unsaturated dicarboxylic acid having 4 to 6 carbon atoms, alkali metal salts thereof, ammonium salts thereof and mixtures thereof; wherein the vinyl ester latex contains less than 5 mol % of structural units of an anhydride of a dicarboxylic acid; and wherein the vinyl ester latex contains less than 10 wt %, based on dry weight of the vinyl ester latex, of structural units of a monoethylenically unsaturated alkyl acrylate monomer containing 2 to 10 carbon atoms.

Aqueous formulations are well known. Notwithstanding, conventional aqueous formulations often comprise a variety of nonbiodegradable ingredients including thickeners. There is a desire in the marketplace to increase the biodegradable content of formulations for consumers (e.g., for home and personal care use). Many conventional thickeners include alkali soluble/swellable latexes, which while not toxic and not posing serious hazards to the environment, are typically not biodegradable.

Accordingly, there remains a need to find new biodegradable ingredients suitable for use as thickeners in aqueous formulations.

The present invention provides a vinyl ester latex comprising: 20 to 80 wt %, based on dry weight of the vinyl ester latex, of structural units of a monoethylenically unsaturated vinyl alkanoate having 4 to 12 carbon atoms; 20 to 80 wt %, based on dry weight of the vinyl ester latex, of structural units of a monoethylenically unsaturated carboxylic acid functionalized vinyl ester having 4 to 12 carbon atoms; 0 to 5 wt %, based on dry weight of the vinyl ester latex, of structural units of a multiethylenically unsaturated crosslinker; 0 to 20 wt %, based on dry weight of the vinyl ester latex, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms; wherein the vinyl ester latex contains less than 1.2 wt %, based on dry weight of the vinyl ester latex, of structural units of 2-acrylamido-2-methyl-propanesulfonic acid; wherein the vinyl ester latex contains less than 10 wt %, based on dry weight of the vinyl ester latex, of structural units of a monoethylenically unsaturated dicarboxylic acid having 4 to 6 carbon atoms, alkali metal salts thereof, ammonium salts thereof and mixtures thereof; wherein the vinyl ester latex contains less than 5 mol % of structural units of an anhydride of a dicarboxylic acid; and wherein the vinyl ester latex contains less than 10 wt %, based on dry weight of the vinyl ester latex, of structural units of a monoethylenically unsaturated alkyl acrylate monomer containing 2 to 10 carbon atoms.

### DETAILED DESCRIPTION

Applicants have surprisingly found that vinyl ester latex, comprising 20 to 80 wt %, based on dry weight of the vinyl ester latex, of structural units of a monoethylenically unsaturated vinyl alkanoate having 4 to 12 carbon atoms; 20 to 80 wt %, based on dry weight of the vinyl ester latex, of structural units of a monoethylenically unsaturated carboxylic acid functionalized vinyl ester having 4 to 12 carbon atoms; 0 to 5 wt %, based on dry weight of the vinyl ester latex, of structural units of a multiethylenically unsaturated crosslinker; 0 to 20 wt %, based on dry weight of the vinyl ester latex, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms; wherein the vinyl ester latex contains less than 1.2 wt %, based on dry weight of the vinyl ester latex, of structural units of 2-acrylamido-2-methyl-propanesulfonic acid; wherein the vinyl ester latex contains less than 10 wt %, based on dry weight of the vinyl ester latex, of structural units of a monoethylenically unsaturated dicarboxylic acid having 4 to 6 carbon atoms, alkali metal salts thereof, ammonium salts thereof and mixtures thereof; wherein the vinyl ester latex contains less than 5 mol % of structural units of an anhydride of a dicarboxylic acid; and wherein the vinyl ester latex contains less than 10 wt %, based on dry weight of the vinyl ester latex, of structural units of a monoethylenically unsaturated alkyl acrylate monomer containing 2 to 10 carbon atoms; can effectively thicken aqueous solutions (particularly surfactant containing aqueous solutions) and also exhibit biodegradability following the procedure of OECD 302B.

Unless otherwise indicated, ratios, percentages, parts, and the like are by weight. Weight percentages (or wt %) in the composition are percentages of dry weight, i.e., excluding any water that may be present in the composition. Percentages of monomer units in the polymer are percentages of solids weight, i.e., excluding any water present in a polymer emulsion.

As used herein, unless otherwise indicated, the terms “weight average molecular weight” and “Mw” are used interchangeably to refer to the weight average molecular weight as measured in a conventional manner with gel permeation chromatography (GPC) and conventional standards, such as polystyrene standards. GPC techniques are discussed in detail in Modem Size Exclusion Chromatography, W. W. Yau, J. J. Kirkland, D. D. Bly; Wiley-Interscience, 1979, and in A Guide to Materials Characterization and Chemical Analysis, J. P. Sibilia; VCH, 1988, p. 81-84. Weight average molecular weights are reported herein in units of Daltons.

Preferably, the vinyl ester latex of the present invention is an aqueous emulsion polymer.

Preferably, the vinyl ester latex of the present invention comprises: 20 to 80 wt % (preferably, 24.89 to 77.89 wt %; more preferably, 39.48 to 74.48 wt %; most preferably, 43.96 to 71.46 wt %), based on dry weight of the vinyl ester latex, of structural units of a monoethylenically unsaturated vinyl alkanoate having 4 to 12 carbon atoms; 20 to 80 wt % (preferably, 22 to 75 wt %; more preferably, 25 to 60 wt %; most preferably, 27.5 to 55 wt %), based on dry weight of the vinyl ester latex, of structural units of a monoethylenically unsaturated carboxylic acid functionalized vinyl ester having 4 to 12 carbon atoms; 0 to 5 wt % (preferably, 0.01 to 2.5 wt %; more preferably, 0.02 to 1 wt %; most preferably, 0.04 to 0.5 wt %), based on dry weight of the vinyl ester latex, of structural units of a multiethylenically unsaturated crosslinker; 0 to 20 wt % (preferably, 0.1 to 5 wt %; more preferably, 0.5 to 4 wt %; most preferably, 1 to 3 wt %), based on dry weight of the vinyl ester latex, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms; wherein the vinyl ester latex contains less than 1.2 wt % (preferably, 0 to 1.1 wt %; more preferably, 0 to 1.0 wt %; still more preferably, 0 to 0.5 wt %; yet more preferably, 0 to 0.1 wt %; most preferably, 0 to 0.01 wt %), based on dry weight of the vinyl ester latex, of structural units of 2-acrylamido-2-methyl-propanesulfonic acid; wherein the vinyl ester latex contains less than 10 wt % (preferably, <5 wt %; more preferably, <1 wt %; still more preferably, <0.1 wt %; most preferably, <detectable limit), based on dry weight of the vinyl ester latex, of structural units of a monoethylenically unsaturated dicarboxylic acid having 4 to 6 carbon atoms, alkali metal salts thereof, ammonium salts thereof and mixtures thereof; wherein the vinyl ester latex contains less than 5 mol % (preferably, <1 mol %; more preferably, <0.1 mol %; most preferably, <the detectable limit) of structural units of an anhydride of a dicarboxylic acid (e.g., malcic anhydride, itaconic anhydride); and wherein the vinyl ester latex contains less than 10 wt % (preferably, <5 wt %; more preferably, <1 wt %; still more preferably, <0.1 wt %; most preferably, <detectable limit), based on dry weight of the vinyl ester latex, of structural units of a monoethylenically unsaturated alkyl acrylate monomer containing 2 to 10 carbon atoms (e.g., methyl acrylate, ethyl acrylate, propyl acrylate, n-butyl acrylate, isobutyl acrylate, 2-ethylhexyl acrylate, methyl methacrylate, ethyl methacrylate, isobutyl methacrylate, 2-ethylhexyl methacrylate).

Preferably, the vinyl ester latex of the present invention comprises: 20 to 80 wt % (preferably, 24.89 to 77.89 wt %; more preferably, 39.48 to 74.48 wt %; most preferably, 43.96 to 71.46 wt %), based on dry weight of the vinyl ester latex, of structural units of a monoethylenically unsaturated vinyl alkanoate having 4 to 12 carbon atoms; wherein the monoethylenically unsaturated vinyl alkanoate having 4 to 12 carbon atoms is selected from the group consisting of vinyl acetate, vinyl propionate, vinyl butyrate, vinyl isobutyrate, vinyl pentanoate, vinyl 3-methyl butanoate, vinyl pivalate, vinyl hexanoate, vinyl 4-methyl pentanoate, vinyl 3,3-dimethyl butanoate, vinyl heptanoate, vinyl 5-methyl hexanoate, vinyl 4,4-dimethyl pentanoate, vinyl octanoate, vinyl 6-methyl heptanoate, vinyl 5,5-dimethyl hexanoate, vinyl nonanoate, vinyl 7-methyl octanoate, vinyl decanoate, vinyl 8-methyl nonanoate, vinyl 6,6-dimethyl heptanoate, vinyl 2-methyl-2-propylhexanoate, vinyl 2-ethyl-2-methylheptanoate, vinyl 2,2-dimethyloctanoate, vinyl 2,2-dimethylheptanoate, vinyl 2-ethyl-2-methylhexanoate, vinyl 2-methyl-2-propylpentanoate, vinyl 2-ethylhexanoate and mixtures thereof. More preferably, the vinyl ester latex of the present invention comprises: 20 to 80 wt % (preferably, 24.89 to 77.89 wt %; more preferably, 39.48 to 74.48 wt %; most preferably, 43.96 to 71.46 wt %), based on dry weight of the vinyl ester latex, of structural units of a monoethylenically unsaturated vinyl alkanoate having 4 to 12 carbon atoms; wherein the monoethylenically unsaturated vinyl alkanoate having 4 to 12 carbon atoms is selected from the group consisting of vinyl acetate, vinyl propionate, vinyl butyrate, vinyl isobutyrate, vinyl pentanoate, vinyl 3-methyl butanoate, vinyl pivalate, vinyl hexanoate, vinyl 4-methyl pentanoate, vinyl 3,3-dimethyl butanoate, vinyl heptanoate, vinyl 5-methyl hexanoate, vinyl 4,4-dimethyl pentanoate, vinyl octanoate, vinyl 6-methyl heptanoate, vinyl 5,5-dimethyl hexanoate and mixtures thereof. Still more preferably, the vinyl ester latex of the present invention comprises: 20 to 80 wt % (preferably, 24.89 to 77.89 wt %; more preferably, 39.48 to 74.48 wt %; most preferably, 43.96 to 71.46 wt %), based on dry weight of the vinyl ester latex, of structural units of a monoethylenically unsaturated vinyl alkanoate having 4 to 12 carbon atoms; wherein the monocthylenically unsaturated vinyl alkanoate having 4 to 12 carbon atoms is selected from the group consisting of vinyl acetate, vinyl propionate, vinyl butyrate, vinyl isobutyrate, vinyl pentanoate, vinyl 3-methyl butanoate, vinyl pivalate, vinyl hexanoate, vinyl 4-methyl pentanoate, vinyl 3,3-dimethyl butanoate and mixtures thereof. Yet more preferably, the vinyl ester latex of the present invention comprises: 20 to 80 wt % (preferably, 24.89 to 77.89 wt %; more preferably, 39.48 to 74.48 wt %; most preferably, 43.96 to 71.46 wt %), based on dry weight of the vinyl ester latex, of structural units of a monoethylenically unsaturated vinyl alkanoate having 4 to 12 carbon atoms; wherein the monoethylenically unsaturated vinyl alkanoate having 4 to 12 carbon atoms is selected from the group consisting of vinyl acetate, vinyl propionate, vinyl butyrate, vinyl isobutyrate and mixtures thereof. Most preferably, the vinyl ester latex of the present invention comprises: 20 to 80 wt % (preferably, 24.89 to 77.89 wt %; more preferably, 39.48 to 74.48 wt %; most preferably, 43.96 to 71.46 wt %), based on dry weight of the vinyl ester latex, of structural units of a monoethylenically unsaturated vinyl alkanoate having 4 to 12 carbon atoms; wherein the monoethylenically unsaturated vinyl alkanoate having 4 to 12 carbon atoms is vinyl acetate.

Preferably, the vinyl ester latex of the present invention comprises: 20 to 80 wt % (preferably, 22 to 75 wt %; more preferably, 25 to 60 wt %; most preferably, 27.5 to 55 wt %), based on dry weight of the vinyl ester latex, of structural units of a monoethylenically unsaturated carboxylic acid functionalized vinyl ester having 4 to 12 carbon atoms; wherein the monoethylenically unsaturated carboxylic acid functionalized vinyl ester having 4 to 12 carbon atoms is selected from the group consisting of 2-oxo-2-(vinyloxy) acetic acid, 3-oxo-3-(vinyloxy) propanoic acid, 4-oxo-4-(vinyloxy) butanoic acid (aka vinyl succinic acid), 5-oxo-5-(vinyloxy) pentanoic acid, 6-oxo-6-(vinyloxy) hexanoic acid (aka vinyl adipic acid), 7-oxo-7-(vinyloxy) heptanoic acid, 8-oxo-8-(vinyloxy) octanoic acid, 9-oxo-9-(vinyloxy) nonanoic acid, 10-oxo-10-(vinyloxy) decanoic acid and mixtures thereof. More preferably, the vinyl ester latex of the present invention comprises: 20 to 80 wt % (preferably, 22 to 75 wt %; more preferably, 25 to 60 wt %; most preferably, 27.5 to 55 wt %), based on dry weight of the vinyl ester latex, of structural units of a monoethylenically unsaturated carboxylic acid functionalized vinyl ester having 4 to 12 carbon atoms; wherein the monoethylenically unsaturated carboxylic acid functionalized vinyl ester having 4 to 12 carbon atoms is selected from the group consisting of 4-oxo-4-(vinyloxy) butanoic acid, 5-oxo-5-(vinyloxy) pentanoic acid, 6-oxo-6-(vinyloxy) hexanoic acid, 7-oxo-7-(vinyloxy) heptanoic acid, 8-oxo-8-(vinyloxy) octanoic acid and mixtures thereof. Still more preferably, the vinyl ester latex of the present invention comprises: 20 to 80 wt % (preferably, 22 to 75 wt %; more preferably, 25 to 60 wt %; most preferably, 27.5 to 55 wt %), based on dry weight of the vinyl ester latex, of structural units of a monoethylenically unsaturated carboxylic acid functionalized vinyl ester having 4 to 12 carbon atoms; wherein the monoethylenically unsaturated carboxylic acid functionalized vinyl ester having 4 to 12 carbon atoms is selected from the group consisting of 5-oxo-5-(vinyloxy) pentanoic acid, 6-oxo-6-(vinyloxy) hexanoic acid, 7-oxo-7-(vinyloxy) heptanoic acid, 8-oxo-8-(vinyloxy) octanoic acid and mixtures thereof. Yet more preferably, the vinyl ester latex of the present invention comprises: 20 to 80 wt % (preferably, 22 to 75 wt %; more preferably, 25 to 60 wt %; most preferably, 27.5 to 55 wt %), based on dry weight of the vinyl ester latex, of structural units of a monoethylenically unsaturated carboxylic acid functionalized vinyl ester having 4 to 12 carbon atoms; wherein the monoethylenically unsaturated carboxylic acid functionalized vinyl ester having 4 to 12 carbon atoms is selected from the group consisting of 6-oxo-6-(vinyloxy) hexanoic acid, 7-oxo-7-(vinyloxy) heptanoic acid, 8-oxo-8-(vinyloxy) octanoic acid and mixtures thereof. Most preferably, the vinyl ester latex of the present invention comprises: 20 to 80 wt % (preferably, 22 to 75 wt %; more preferably, 25 to 60 wt %; most preferably, 27.5 to 55 wt %), based on dry weight of the vinyl ester latex, of structural units of a monoethylenically unsaturated carboxylic acid functionalized vinyl ester having 4 to 12 carbon atoms; wherein the monoethylenically unsaturated carboxylic acid functionalized vinyl ester having 4 to 12 carbon atoms is 6-oxo-6-(vinyloxy) hexanoic acid.

Preferably, the vinyl ester latex of the present invention comprises: 0 to 5 wt % (preferably, 0.01 to 2.5 wt %; more preferably, 0.02 to 1 wt %; most preferably, 0.04 to 0.5 wt %), based on dry weight of the vinyl ester latex, of structural units of a multiethylenically unsaturated crosslinker; wherein the multiethylenically unsaturated crosslinker is selected from the group consisting of multiethylenically unsaturated crosslinkers having an average of two or three vinyl groups per molecule. More preferably, the vinyl ester latex of the present invention comprises: 0 to 5 wt % (preferably, 0.01 to 2.5 wt %; more preferably, 0.02 to 1 wt %; most preferably, 0.04 to 0.5 wt %), based on dry weight of the vinyl ester latex, of structural units of a multiethylenically unsaturated crosslinker; wherein the multiethylenically unsaturated crosslinker is selected from the group consisting of allyl(meth) acrylate, tripropylene glycol di(meth) acrylate, diethylene glycol di(meth) acrylate, ethylene glycol di(meth) acrylate, 1,6-hexanediol di(meth) acrylate, 1,3-butylene glycol di(meth) acrylate, polyalkylene glycol di(meth) acrylate, diallyl phthalate, trimethylolpropane tri(meth) acrylate, divinylbenzene, divinyl toluene, trivinyl benzene, divinyl naphthalene and mixtures thereof. Most preferably, the vinyl ester latex of the present invention comprises: 0 to 5 wt % (preferably, 0.01 to 2.5 wt %; more preferably, 0.02 to 1 wt %; most preferably, 0.04 to 0.5 wt %), based on dry weight of the vinyl ester latex, of structural units of a multiethylenically unsaturated crosslinker; wherein the multiethylenically unsaturated crosslinker is diallyl phthalate.

Preferably, the vinyl ester latex of the present invention comprises: 0 to 20 wt % (preferably, 0.1 to 5 wt %; more preferably, 0.5 to 4 wt %; most preferably, 1 to 3 wt %), based on dry weight of the vinyl ester latex, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms and wherein the other monoethylenically unsaturated monomer is selected from the group consisting of alkyl(meth) acrylate, alkyl(meth) acrylamide, vinyl ether, vinyl sulfonic acid, styrene sulfonic acid, acrylamidopropylmethane sulfonic acid, (meth)acrylic acid, maleic acid, salts thereof and mixtures thereof. More preferably, the vinyl ester latex of the present invention comprises: 0 to 20 wt % (preferably, 0.1 to 5 wt %; more preferably, 0.5 to 4 wt %; most preferably, 1 to 3 wt %), based on dry weight of the vinyl ester latex, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms and wherein the other monoethylenically unsaturated monomer is selected from the group consisting of C₁₋₄ alkyl(meth) acrylate, C₁₋₄ alkyl(meth) acrylamide, vinyl ether, vinyl sulfonic acid, styrene sulfonic acid, acrylamidopropylmethane sulfonic acid, (meth)acrylic acid, maleic acid, salts thereof and mixtures thereof. Still more preferably, the vinyl ester latex of the present invention comprises: 0 to 20 wt % (preferably, 0.1 to 5 wt %; more preferably, 0.5 to 4 wt %; most preferably, 1 to 3 wt %), based on dry weight of the vinyl ester latex, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms and wherein the other monoethylenically unsaturated monomer is selected from the group consisting of methyl(meth) acrylate, ethyl(meth) acrylate, methyl(meth) acrylamide, ethyl(meth) acrylamide, vinyl ether, vinyl sulfonic acid, styrene sulfonic acid, (meth)acrylic acid, maleic acid, salts thereof and mixtures thereof. Most preferably, the vinyl ester latex of the present invention comprises: 0 to 20 wt % (preferably, 0.1 to 5 wt %; more preferably, 0.5 to 4 wt %; most preferably, 1 to 3 wt %), based on dry weight of the vinyl ester latex, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms and wherein the other monoethylenically unsaturated monomer is selected from the group consisting of vinyl sulfonic acid, salts of vinyl sulfonic acid and mixtures thereof.

Preferably, the vinyl ester latex of the present invention contains 0 to 1.1 wt % (preferably, 0 to 1.0 wt %; more preferably, 0 to 0.5 wt %; still more preferably, 0 to 0.1 wt %; most preferably, 0 to 0.01 wt %), based on dry weight of the vinyl ester latex, of structural units of 2-acrylamido-2-methyl-propanesulfonic acid.

Preferably, the vinyl ester latex of the present invention contains less than 5 wt % (preferably, <1 wt %; more preferably, <0.1 wt %; most preferably, <detectable limit), based on dry weight of the vinyl ester latex, of structural units of a monoethylenically unsaturated dicarboxylic acid having 4 to 6 carbon atoms, alkali metal salts thereof, ammonium salts thereof and mixtures thereof.

Preferably, the vinyl ester latex of the present invention contains less than 5 mol % (preferably, <1 mol %; more preferably, <0.1 mol %; most preferably, <the detectable limit) of structural units of an anhydride of a dicarboxylic acid. More preferably, the vinyl ester latex of the present invention contains less than 5 mol % (preferably, <1 mol %; more preferably, <0.1 mol %; most preferably, <the detectable limit) of structural units of an anhydride of a dicarboxylic acid selected from the group consisting of maleic anhydride, itaconic anhydride and mixtures thereof.

Preferably, the vinyl ester latex of the present invention contains less than 10 wt % (preferably, <5 wt %; more preferably, <1 wt %; still more preferably, <0.1 wt %; most preferably, <detectable limit), based on dry weight of the vinyl ester latex, of structural units of a monoethylenically unsaturated alkyl acrylate monomer containing 2 to 10 carbon atoms. More preferably, the vinyl ester latex of the present invention contains less than 10 wt % (preferably, <5 wt %; more preferably, <1 wt %; still more preferably, <0.1 wt %; most preferably, <detectable limit), based on dry weight of the vinyl ester latex, of structural units of a monoethylenically unsaturated alkyl acrylate monomer containing 2 to 10 carbon atoms selected from the group consisting of methyl acrylate, ethyl acrylate, propyl acrylate, n-butyl acrylate, isobutyl acrylate, 2-ethylhexyl acrylate, methyl methacrylate, ethyl methacrylate, isobutyl methacrylate, 2-ethylhexyl methacrylate and mixtures thereof.

Preferably, the structural units of monoethylenically unsaturated vinyl alkanoate having 4 to 12 carbon atoms and the structural units of monoethylenically unsaturated carboxylic acid functionalized vinyl ester having 4 to 12 carbon atoms account for a total of 70 to 100 wt % (more preferably, 75 to 100 wt %; still more preferably, 80 to 100 wt %; yet more preferably, 85 to 99.9 wt %; yet still more preferably, 90 to 99.5 wt %; most preferably, 95 to 99 wt %) of the vinyl ester latex, based on dry weight of the vinyl ester latex.

Preferably, the vinyl ester latex of the present invention contains less than 0.1 mol % (preferably, <0.01 mol %; more preferably, <0.001 mol %; most preferably, <detectable limit) of structural units of a monoethylenically unsaturated amide containing monomer. More preferably, the vinyl ester latex of the present invention contains less than 0.1 mol % (preferably, <0.01 mol %; more preferably, <0.001 mol %; most preferably, <detectable limit) of structural units of a monoethylenically unsaturated amide containing monomer selected from the group consisting of N-vinylformamide; (meth) acrylamide; 2-acrylamido-2-methyl-propanesulfonic acid (AMPS); 3-(methacrylamide) propyl trimethylammonium chloride (MAPTAC) and mixtures thereof.

Preferably, the vinyl ester latex of the present invention is an aqueous emulsion polymer. More preferably, the vinyl ester latex of the present invention is an aqueous emulsion polymer, wherein aqueous emulsion polymer contains less than 2 wt % (preferably, <1 wt %; more preferably, <0.01 wt %; still more preferably, <0.001 wt %; most preferably, <detectable limit), based on dry weight of the vinyl ester latex, of a drying oil. Most preferably, the vinyl ester latex of the present invention is an aqueous emulsion polymer, wherein aqueous emulsion polymer contains less than 2 wt % (preferably, <1 wt %; more preferably, <0.01 wt %; still more preferably, <0.001 wt %; most preferably, <detectable limit), based on dry weight of the vinyl ester latex, of a drying oil selected from the group consisting of safflower oil, linseed oil, castor oil, oiticica oil, sunflower oil, soybean oil, perilla oil, tall oil, dehydrated castor oil, poppy oil, tung oil, very long oil alkyds, long oil alkyds and mixtures thereof.

Preferably, the vinyl ester latex of the present invention is biodegradable as determined following the procedure of OECD 302B. More preferably, the vinyl ester latex of the present invention has inherent, ultimate biodegradability as determined following the procedure of OECD 302B.

The vinyl ester latex of the present invention can be made using conventional or otherwise known polymerization techniques.

The vinyl ester latex of the present invention is suitable for use as a thickening polymer in various aqueous formulations. In particular, the vinyl ester latex of the present invention is suitable for use as a thickening polymer in surfactant containing aqueous formulations, for example, personal care formulations (e.g., shampoo, body wash, hand soap, conditioner) and home care formulations (e.g., hard surface cleaners).

Some embodiments of the present invention will now be described in detail in the following Examples.

### Comparative Examples C1-C2 and Examples 1-18: Vinyl Ester Latex

To a glass reactor was charged a mixture of deionized water (65.5 g) and an aqueous solution of lauryl ethoxylated sulfate surfactant (2.4 g, 31 wt % available from BASF under tradename Disponil FES-32). The reactor contents were then heated to 30° C. with stirring. Separately, in a container a monomer emulsion (ME) was prepared by vortex mixing a combination of deionized water (3.4 g), an aqueous solution of secondary C₁₃ alkyl ethoxylate (0.23 g, 70 wt % available from the Dow Chemical Company under the tradename Tergitol™ 15-S-40), an aqueous solution of lauryl ethoxylated sulfate surfactant (0.45 g, 31 wt %), vinyl alkanoate monomer(s), A, as identified and in the amount noted in TABLE 1 and an aqueous solution of other monomer C, (if any), in the amount noted in TABLE 1. The vortexed ME was then added to the reactor with continued stirring. The ME container was then rinsed forward into the reactor with deionized water (6 g). After a 5 min. hold, a carboxylic acid functionalized vinyl ester monomer, B, as identified and in the amount noted in TABLE 1 was added to the reactor. A crosslinker, D, if any, as identified and in the amount noted in TABLE 1 was added to the reactor. After a 2 min. hold, an aqueous solution of ferrous sulfate heptahydrate (1.2 g, 0.015 wt %) was then added to the reactor. After a 1 min. hold, a solution of ammonium persulfate (0.16 g) in deionized water (1.7 g) was added to the reactor. After a 1 min. hold, a sulfur-based formaldehyde free reducing agent (0.212 g, Bruggolite FF6 M available from Brueggemann) in water (3.0 g) was added to the reactor. After 30 min, another solution of ammonium persulfate (0.16 g) in deionized water (1.7 g) was added to the reactor. After a 1 min. hold another solution of sulfur-based formaldehyde free reducing agent (0.212 g, Bruggolite FF6 M available from Brueggemann) in water (3.0 g) was added to the reactor. After 15 min., the reactor product was then collected for analysis.

TABLE 1

| | Monomer A | | | | Monomer B | | Monomer C | | X-linker D | |
|---|---|---|---|---|---|---|---|---|---|---|
| Example | Type | (g) | Type | (g) | Type | (g) | Type | (g) | Type | (g) |
| C1 | VA | 16.62 | — | — | — | — | — | — | — | — |
| C2 | VA | 14.96 | — | — | VSA | 1.66 | — | — | — | — |
| 1 | VA | 11.5 | — | — | VSA | 4.8 | SVS | 0.32 | — | — |
| 2 | VA | 11.5 | — | — | VSA | 4.8 | SVS | 0.32 | DAP | 0.008 |
| 3 | VA | 8.15 | — | — | VSA | 8.15 | SVS | 0.32 | DAP | 0.008 |
| 4 | VA | 8.15 | — | — | VSA | 8.15 | SVS | 0.32 | DAP | 0.025 |
| 5 | VA | 11.5 | — | — | VAA | 4.8 | SVS | 0.32 | DAP | 0.008 |
| 6 | VA | 8.15 | — | — | VAA | 8.15 | SVS | 0.32 | DAP | 0.008 |
| 7 | VA | 11.63 | — | — | VSA | 4.99 | — | — | — | — |
| 8 | VA | 11.63 | — | — | VSA | 4.99 | — | — | DAP | 0.008 |
| 9 | VA | 8.31 | — | — | VSA | 8.31 | — | — | DAP | 0.008 |
| 10 | VA | 11.63 | — | — | VSA | 4.99 | — | — | DAP | 0.025 |
| 11 | VA | 8.31 | — | — | VSA | 8.31 | — | — | DAP | 0.025 |
| 12 | VA | 11.63 | — | — | VSA | 4.99 | — | — | DAP | 0.060 |
| 13 | VA | 8.31 | — | — | VSA | 8.31 | — | — | DAP | 0.060 |
| 14 | VA | 7.48 | VVA | 4.15 | VSA | 4.99 | — | — | DAP | 0.008 |
| 15 | VA | 11.63 | — | — | VAA | 4.99 | — | — | DAP | 0.008 |
| 16 | VA | 8.31 | — | — | VAA | 8.31 | — | — | DAP | 0.008 |
| 17 | VA | 9.87 | — | — | VSA | 6.58 | SVS | 0.17 | — | — |
| 18 | VA | 8.21 | VVA | 1.66 | VSA | 6.58 | SVS | 0.17 | DAP | 0.071 |

VA—Vinyl acetate
VSA—4-oxo-4-(vinyloxy)butanoic acid (aka vinyl succinic acid)
VAA—6-oxo-6-(vinyloxy)hexanoic acid (aka vinyl adipic acid)
SVS—24 wt % aqueous solution of sodium vinyl sulfonate
DAP—Diallyl phthalate
VVA—Vinyl 2-methyl-2-propylhexanoate

### Comparative Example C3: Vinyl Ester Latex

A 250-mL round-bottom flask was equipped with a glass rod propeller with a Teflon stir blade, a condenser, and a thermocouple. The propeller was driven by an overhead mechanical stirrer, and the thermocouple was connected to a J-KEM temperature controller connected to a pneumatic pot lifter to achieve the desired temperature. The flask was charged with deionized water (47.7 g), lauryl ethoxylated sulfate surfactant (2.66 g, 31 wt % available from BASF under tradename Disponil FES-32), and an aqueous ferrous sulfate heptahydrate solution (0.26 g, 0.15 wt %). The temperature controller was set to 70° C. and the flask was placed under nitrogen.

A first glass jar was charged with vinyl 2-methyl-2-propylhexanoate (3.56 g), vinyl acetate (21.28 g), vinyl succinic acid (10.25 g) and diallyl phthalate (0.071 g), and mixed to form a homogeneous mixture under moderate heat to serve as a monomer feed.

A second glass jar was charged with deionized water (33.80 g), 2-acrylamido-2-methyl-propanesulfonic acid (0.11 g), an aqueous solution of secondary C₁₃ alkyl ethoxylate (0.25 g, 70 wt % available from the Dow Chemical Company under the tradename Tergitol™ 15-S-40) and lauryl ethoxylated sulfate surfactant (1 g, 31 wt % available from BASF under tradename Disponil FES-32) to serve as an aqueous cofeed.

A third glass jar was charged with a solution of ammonium persulfate (0.22 g) in deionized water (12.0 g) and an aqueous solution of tert-butyl hydroperoxide (0.10 g, 70% active) to serve as cofeed catalyst.

A fourth glass jar was charged with a solution of sulfur-based formaldehyde free reducing agent (0.43 g, Bruggolite FF6 M available from Brueggemann) in deionized water (12.0 g) to serve as a cofeed activator.

When the flask contents reached 70° C., 2-acrylamido-2-methyl-propanesulfonic acid (0.32 g) in deionized water (1.4 g) was transferred into the flask as a shot addition. Then addition of the cofeed catalyst and the cofeed activator solutions to the flask began at a rate of 0.13 g/min with a targeted total feed time of 95 min. After 5 min, the addition of the monomer feed and the aqueous cofeed solutions to the flask began at a rate of 0.44 g/min with a targeted total feed time of 80 min. The controller set point temperature remained at 70° C. After all four feeds to the flask were complete, the flask contents were held at 70° C. for 15 min. and then cooling began. When the flask contents reached 60° C., an aqueous ammonia solution (0.50 g, 30% actives) was added to the flask. Once the flask contents cooled to ambient temperature, they were passed through a nylon filter (mesh size: 150 μm) to yield a white emulsion with a solids content of 19.5 wt %, a pH of 4.1, a particle size (by dynamic light scattering) of 201 nm (dispersity, 0.056) and a residual vinyl acetate content (by headspace gas chromatography) of 1,756 ppm.

### Example 19: Vinyl Ester Latex

A 250-mL round-bottom flask was equipped with a glass rod propeller with a Teflon stir blade, a condenser, and a thermocouple. The propeller was driven by an overhead mechanical stirrer, and the thermocouple was connected to a J-KEM temperature controller and connected to a pneumatic pot lifter to achieve the desired temperature. The flask was first charged with deionized water (32.0 g) and lauryl ethoxylated sulfate surfactant (2.66 g, 31 wt % available from BASF under tradename Disponil FES-32). The temperature controller was set to 70° C. and the flask was placed under nitrogen.

A first glass jar was charged with vinyl 2-methyl-2-propylhexanoate (3.56 g), vinyl acetate (17.44 g), vinyl succinic acid (14.17 g) and diallyl phthalate (0.071 g), and mixed to form a homogeneous mixture under moderate heat to serve as a monomer feed.

A second glass jar was charged with deionized water (33.80 g), an aqueous solution of sodium vinyl sulfonate (0.712 g, 25% active), an aqueous solution of secondary C₁₃ alkyl ethoxylate (0.51 g, 70 wt % available from the Dow Chemical Company under the tradename Tergitol™ 15-S-40) and lauryl ethoxylated sulfate surfactant (1.0 g, 31 wt % available from BASF under tradename Disponil FES-32) to serve as an aqueous cofeed.

A third glass jar was charged with a solution of ammonium persulfate (0.1 g) in deionized water (10.0 g) and an aqueous solution of tert-butyl hydroperoxide (0.042 g, 70% active) to serve as cofeed catalyst.

A fourth glass jar was charged with a solution of sulfur-based formaldehyde free reducing agent (0.065 g, Bruggolite FF6 M available from Brueggemann) in deionized water (10.0 g) to serve as a cofeed activator.

When the flask contents reached 70° C., two shot additions were charged into the flask contents in the following order: first, an aqueous sodium vinyl sulfonated solution (0.712 g, 25% active) and deionized water (1.4 g); and second, an aqueous solution of ferrous sulfate heptahydrate (0.26 g, 0.15%). Then the addition of the cofeed catalyst and the cofeed activator solutions to the flask began at a rate of 0.11 g/min with a targeted total feed time of 95 min. After 5 min, the addition of the monomer feed and the aqueous cofeed to the flask began at a rate of 0.44 g/min with a targeted total feed time of 80 min. The controller set point temperature remained at 70° C. After all four feeds to the flask were completed, the flask contents were held at 70° C. for 15 min. and then cooling began. When the flask contents reached 60° C., an aqueous ammonia solution (0.50 g, 30% active) was added into the flask contents. Then separate chase catalyst feeds were added to the flask contents at a rate of 0.17 g/min over 30 min.—first stream, ammonium persulfate (9.3 mg), tert-butyl hydroperoxide aqueous solution (31 mg, 70% active) and deionized water (5.0 g); second stream, sodium metabisulfite (47 mg) in deionized water (5 g). After the two chase feeds were completed, the flask contents were held at 60° C. for 15 min. Then the flask contents were cooled to ambient temperature. Once ambient temperature was reached, the flask contents were passed through a nylon filter (mesh size: 150 μm) to yield a white emulsion with a solids content of 22.89 wt %, a pH of 3.3, a particle size (by dynamic light scattering) of 181 nm (dispersity, 0.001) and a residual vinyl acetate content (by headspace gas chromatography) of 165 ppm.

### Example 20: Vinyl Ester Latex

A 250-mL round-bottom flask was equipped with a glass rod propeller with a Teflon stir blade, a condenser, and a thermocouple. The propeller was driven by an overhead mechanical stirrer, and the thermocouple was connected to a J-KEM temperature controller and connected to a pneumatic pot lifter to achieve the desired temperature. The flask was first charged with deionized water (32 g) and lauryl ethoxylated sulfate surfactant (2.66 g, 31 wt % available from BASF under tradename Disponil FES-32). The temperature controller was set to 70° C. and the flask was placed under nitrogen.

A first glass jar was charged with vinyl 2-methyl-2-propylhexanoate (3.56 g), vinyl acetate (17.44 g), vinyl succinic acid (14.17 g) and diallyl phthalate (0.071 g), and mixed to form a homogeneous mixture under moderate heat to serve as a monomer feed.

A second glass jar was charged with deionized water (33.80 g), an aqueous solution of sodium vinyl sulfonate (0.712 g, 25% active), an aqueous solution of secondary C₁₃ alkyl ethoxylate (0.51 g, 70 wt % available from the Dow Chemical Company under the tradename Tergitol™ 15-S-40) and lauryl ethoxylated sulfate surfactant (1 g, 31 wt % available from BASF under tradename Disponil FES-32) to serve as an aqueous cofeed.

A third glass jar was charged with a solution of sodium persulfate (0.071 g) in deionized water (10.0 g) and an aqueous solution of tert-butyl hydroperoxide (0.028 g, 70% active) to serve as cofeed catalyst.

A fourth glass jar was charged with a solution of isoascorbic acid (0.057) in deionized water (10.0 g) to serve as a cofeed activator.

When the flask contents reached 70° C., two shot additions were charged into the flask contents in the following order: first, an aqueous sodium vinyl sulfonated solution (0.712 g, 25% active) and deionized water (1.4 g); and second, an aqueous solution of ferrous sulfate heptahydrate (0.26 g, 0.15%). Then the addition of the cofeed catalyst and the cofeed activator solutions to the flask began at a rate of 0.11 g/min with a targeted total feed time of 95 min. After 5 min, the addition of the monomer feed and the aqueous cofeed to the flask began at a rate of 0.44 g/min with a targeted total feed time of 80 min. The controller set point temperature remained at 70° C. After all four feeds to the flask were completed, the flask contents were held at 70° C. for 15 min. and then cooling began. When the flask contents reached 60° C., an aqueous ammonia solution (0.5 g, 30% active) was added into the flask contents as a shot addition. Then separate chase feeds were added to the flask contents at a rate of 0.5 g/min over 10 min.—first stream, tert-butyl hydroperoxide aqueous solution (85 mg, 70% active) and deionized water (5.0 g); second stream, sodium metabisulfite (62 mg) in deionized water (5.0 g). After the two chase feeds were completed, the flask contents were held at 60° C. for 15 min. Then the flask contents were cooled to ambient temperature. Once ambient temperature was reached, the flask contents were passed through a nylon filter (mesh size: 150 μm) to yield a white emulsion with a solids content of 22.21 wt %, a pH of 3.8, a particle size (by dynamic light scattering) of 186 nm (dispersity, 0.050) and a residual vinyl acetate content (by headspace gas chromatography) of 177 ppm.

### Thickening Performance and Turbidity

The viscosity of aqueous solutions of the vinyl ester latexes prepared according to Comparative Examples C1-C3 and Examples 1-20 were measured at various concentrations, as noted, with a Brookfield viscometer, using a spindle, as noted, at 3 rpm. The pH of the solutions were adjusted to 7-8 using sodium hydroxide (0.5 N). The results are provided in TABLE 3.

The turbidity of the pH adjusted aqueous solution of vinyl ester latex was measured using a turbidity meter at 21° C. The meter was calibrated according to instructions included with the machine. The measured turbidities in Nephelometric Turbidity Units (NTU) are provided in TABLE 3.

The viscosity of aqueous solution of the vinyl ester latexes prepared according to Comparative Example C3 and Examples 1-6 and 17-20 were also measured at 1 or 5 wt %, as noted in TABLE 4, with a Brookfield viscometer, using a spindle and at rpm noted. The pH of the solutions were adjusted to 7-8 using sodium hydroxide (0.5 N). The results are provided in TABLE 4.

TABLE 3

| | | Polymer Concentration (wt %) | | | | | |
|---|---|---|---|---|---|---|---|
| | | 1 | 2 | 5 | 1 | 2 | 5 |
| Latex | Spindle | Viscosity (CP) | | | Turbidity (NTU) | | |
| Comp. Ex. C1 | — | — | — | — | >1,000 | — | — |
| Comp. Ex. C2 | — | — | — | — | >1,000 | — | — |
| Comp. Ex. C3 | LV-1 (61) | 0 | 0 | 0 | — | — | 45 |
| Example 1 | LV-1 (61) | — | 44 | — | — | 0.76 | — |
| Example 2 | LV-1 (61) | — | 88 | — | — | 1.69 | — |
| Example 3 | LV-1 (61) | — | 294 | — | — | 3.12 | — |
| Example 4 | LV-1 (61) | — | 276 | — | — | 15 | — |
| Example 5 | LV-2 (62) | — | 2,010 | — | — | 1.97 | — |
| Example 6 | LV-2 (62) | — | 2,610 | — | — | 4.66 | — |
| Example 7 | LV-1 (61) | 14 | — | — | Hazy | — | — |
| Example 8 | LV-1 (61) | 74 | 358 | — | Clear | — | — |
| Example 9 | LV-1 (61) | 98 | 226 | — | Clear | — | — |
| Example 10 | LV-1 (61) | 60 | 88 | — | Clear | — | — |
| Example 11 | LV-1 (61) | 126 | 562 | — | Clear | — | — |
| Example 12 | LV-1 (61) | 40 | 532 | — | Clear | — | — |
| Example 13 | LV-1 (61) | 30 | 40 | — | Clear | — | — |
| Example 14 | LV-1 (61) | 14 | 18 | — | Clear | — | — |
| Example 15 | LV-1 (61) | 606 | 1,282 | — | Clear | — | — |
| Example 16 | LV-1 (61) | — | 1,158 | — | Clear | — | — |
| Example 17 | LV-1 (61) | 20 | 32 | 28 | — | — | 1.4 |
| Example 18 | LV-1 (61) | 10 | 38 | 5,080 | — | — | 88 |
| Example 19 | LV-1 (61) | 10 | 16 | 44 | — | — | 26 |
| Example 20 | LV-1 (61) | 10 | 12 | 14 | — | — | 2.9 |

TABLE 4

| | | | RPM | | | |
|---|---|---|---|---|---|---|
| | | | 6 | 12 | 30 | 60 |
| Latex | wt % | Spindle | Viscosity (cP) | | | |
| Comp. Ex. C3 | 5 | LV-3 (63) | 60 | 40 | 24 | 22 |
| Example 1 | 1 | LV-1 (61) | 28 | 26 | 24 | 24 |
| Example 2 | 1 | LV-1 (61) | 69 | 61 | 53 | 45 |
| Example 3 | 1 | LV-1 (61) | 202 | 146 | 98 | 75 |
| Example 4 | 1 | LV-1 (61) | 185 | 134 | 90 | 70.2 |
| Example 5 | 1 | LV-2 (62) | 1,245 | 810 | 464 | 317 |
| Example 6 | 1 | LV-2 (62) | 1,605 | 1,043 | 604 | 420 |
| Example 17 | 5 | LV-3 (63) | 120 | 100 | 72 | 60 |
| Example 18 | 5 | LV-3 (63) | 4,090 | 3,010 | 1,850 | 1,250 |
| Example 19 | 5 | LV-3 (63) | 140 | 130 | 108 | 96 |
| Example 20 | 5 | LV-3 (63) | <DL | 40 | 32 | 30 |

### Comparative Examples CF1-CF4 and Examples F1-F6: Laundry Detergent

A laundry detergent formulation was prepared in each of Comparative Examples CF1-CF4 and Examples F1-F6 having the recipe noted in TABLE 5. The formulations were prepared by combining ingredients, in the order listed in TABLE 5, while constantly mixing with an overhead mixer to give a vortex. The anionic surfactants, water and solvent were mixed well until all components were incorporated before the nonionic surfactant (pre-melted at 50° C.) was added. The pH was then adjusted to 8.5 with a NaOH solution. The vinyl ester latex, as indicated in TABLE 5, was then added to the formulation while mixing with the overhead mixer in sufficient quantity to provide 1.2 wt % active vinyl ester latex in the formulation. The pH was adjusted back to 8.5, as necessary, using a NaOH or a HCl solution. Then water was added, as needed, to complete the formulation to 100 wt %.

TABLE 5

| | Example | | | | | | | | | |
|---|---|---|---|---|---|---|---|---|---|---|
| Ingredient | CF1 | CF2 | CF3 | CF4 | F1 | F2 | F3 | F4 | F5 | F6 |
| Water | 19 | 19 | 19 | 19 | 19 | 19 | 19 | 19 | 19 | 19 |
| Linear alkyl benzene sulfonate¹ | 10.9 | 10.9 | 10.9 | 10.9 | 10.9 | 10.9 | 10.9 | 10.9 | 10.9 | 10.9 |
| Propylene glycol | 5 | 5 | 5 | 5 | 5 | 5 | 5 | 5 | 5 | 5 |
| Ethanol | 2 | 2 | 2 | 2 | 2 | 2 | 2 | 2 | 2 | 2 |
| Sodium lauryl ethyoxysulfate² | 6.7 | 6.7 | 6.7 | 6.7 | 6.7 | 6.7 | 6.7 | 6.7 | 6.7 | 6.7 |
| Non-ionic surfactant³ | 8 | 8 | 8 | 8 | 8 | 8 | 8 | 8 | 8 | 8 |
| NaOH solution | as needed to adjust pH to 8.5 | | | | | | | | | |
| Commercial ASE thickener⁴ | — | 6.67 | — | — | — | — | — | — | — | — |
| Commercial HASE thickener⁵ | — | — | 4.0 | — | — | — | — | — | — | — |
| Commercial rheology modifier⁶ | — | — | — | 6.66 | — | — | — | — | — | — |
| Product of Example 1 | — | — | — | — | 7.84 | — | — | — | — | — |
| Product of Example 2 | — | — | — | — | — | 7.85 | — | — | — | — |
| Product of Example 3 | — | — | — | — | — | — | 8.16 | — | — | — |
| Product of Example 4 | — | — | — | — | — | — | — | 8.0 | — | — |
| Product of Example 5 | — | — | — | — | — | — | — | — | 7.15 | — |
| Product of Example 6 | — | — | — | — | — | — | — | — | — | 7.15 |

| | |
|---|---|
| NaOH or HCl solution | as needed to adjust pH to 8.5 |
| Water | q.s. 100 |

¹Nacconal 90G from Stepan Company
²Steol CS-460 from Stepan Company
³Biosoft N25-7 from Stepan Company
⁴ACUSOL ™ 810A rheology modifier from The Dow Chemical Company
⁵ACUSOL ™ 823 rheology modifier from The Dow Chemical Company
⁶ACUSOL ™ 842 rheology modifier from The Dow Chemical Company

### Viscosity of Laundry Detergent Formulations

The viscosity of the laundry detergent formulations prepared according to Comparative Examples CF1-CF4 and Examples F1-F6 were measured with a Brookfield viscometer, using a LV-2 (62) spindle at 3 rpm. The results are provided in TABLE 6.

TABLE 6

| Laundry Detergent Formulation | Viscosity (cP) |
|---|---|
| Comparative Example CF1 | 380 |
| Comparative Example CF2 | 1,560 |
| Comparative Example CF3 | 1,220 |
| Comparative Example CF4 | 1,700 |
| Example F1 | 680 |
| Example F2 | 1,020 |
| Example F3 | 540 |
| Example F4 | 1,040 |
| Example F5 | 1,530 |
| Example F6 | 1,460 |

### Biodegradability

The biodegradability of a vinyl ester latex prepared according to Example 1 was evaluated according to the inherent aerobic biodegradation test procedure set forth in OECD 302B. The results are provided in TABLE 7.

TABLE 7

| | % biodeg by dissolved organic carbon (DOC) removal at | | | | | | |
|---|---|---|---|---|---|---|---|
| | | | | | Day | Day | Day |
| Latex | Day 0 | Day 1 | Day 7 | Day 14 | 21 | 28 | 35 |
| Example 1 | 0 | 32 | 90 | 91 | 90 | 92 | 93 |

We claim:

1. A vinyl ester latex, comprising:
20 to 80 wt %, based on dry weight of the vinyl ester latex, of structural units of a monoethylenically unsaturated vinyl alkanoate having 4 to 12 carbon atoms;
20 to 80 wt %, based on dry weight of the vinyl ester latex, of structural units of a monoethylenically unsaturated carboxylic acid functionalized vinyl ester having 4 to 12 carbon atoms;
0 to 5 wt %, based on dry weight of the vinyl ester latex, of structural units of a multiethylenically unsaturated crosslinker;
0 to 20 wt %, based on dry weight of the vinyl ester latex, of structural units of an other monoethylenically unsaturated monomer, wherein the other monoethylenically unsaturated monomer is different from the monoethylenically unsaturated vinyl alkanoate having 4 to 12 carbon atoms and the monoethylenically unsaturated carboxylic acid functionalized vinyl ester having 4 to 12 carbon atoms;
wherein the vinyl ester latex contains less than 1.2 wt %, based on dry weight of the vinyl ester latex, of structural units of 2-acrylamido-2-methyl-propanesulfonic acid;
wherein the vinyl ester latex contains less than 10 wt %, based on dry weight of the vinyl ester latex, of structural units of a monoethylenically unsaturated dicarboxylic acid having 4 to 6 carbon atoms, alkali metal salts thereof, ammonium salts thereof and mixtures thereof;
wherein the vinyl ester latex contains less than 5 mol % of structural units of an anhydride of a dicarboxylic acid; and
wherein the vinyl ester latex contains less than 10 wt %, based on dry weight of the vinyl ester latex, of structural units of a monoethylenically unsaturated alkyl acrylate monomer containing 2 to 10 carbon atoms.

2. The vinyl ester latex of claim 1, wherein the structural units of monoethylenically unsaturated vinyl alkanoate having 4 to 12 carbon atoms and the structural units of monoethylenically unsaturated carboxylic acid functionalized vinyl ester having 4 to 12 carbon atoms account for a total of 70 to 100 wt % of the vinyl ester latex, based on dry weight of the vinyl ester latex.

3. The vinyl ester latex of claim 2, wherein the vinyl ester latex contains less than 0.1 mol % of structural units of a monoethylenically unsaturated amide containing monomer.

4. The vinyl ester latex of claim 3, wherein the structural units of monoethylenically unsaturated vinyl alkanoate having 4 to 12 carbon atoms are selected from the group of structural units consisting of vinyl acetate, vinyl propionate, vinyl butyrate, vinyl isobutyrate, vinyl pentanoate, vinyl 3-methyl butanoate, vinyl pivalate, vinyl hexanoate, vinyl 4-methyl pentanoate, vinyl 3,3-dimethyl butanoate, vinyl heptanoate, vinyl 5-methyl hexanoate, vinyl 4,4-dimethyl pentanoate, vinyl octanoate, vinyl 6-methyl heptanoate, vinyl 5,5-dimethyl hexanoate and mixtures thereof.

5. The vinyl ester latex of claim 4, wherein the structural units of monoethylenically unsaturated carboxylic acid functionalized vinyl ester having 4 to 12 carbon atoms are selected from the group of structural units consisting of 4-oxo-4-(vinyloxy) butanoic acid, 5-oxo-5-(vinyloxy) pentanoic acid, 6-oxo-6-(vinyloxy) hexanoic acid, 7-oxo-7-(vinyloxy) heptanoic acid, 8-oxo-8-(vinyloxy) octanoic acid and mixtures thereof.

6. The vinyl ester latex of claim 5, wherein the vinyl ester latex comprises 0.01 to 2.5 wt %, based on dry weight of the vinyl ester latex, of structural units of the multiethylenically unsaturated crosslinker.

7. The vinyl ester latex of claim 6, wherein the multiethylenically unsaturated crosslinker is diallyl phthalate.

8. The vinyl ester latex of claim 7, further comprising:
0.1 to 5 wt %, based on dry weight of the vinyl ester latex, of structural units of the other monoethylenically unsaturated monomer; wherein the other monoethylenically unsaturated monomer is selected from the group consisting of (meth) acrylate, (meth) acrylamide, vinyl ether, vinyl sulfonic acid, styrene sulfonic acid, acrylamidopropylmethane sulfonic acid, (meth)acrylic acid, maleic acid, salts thereof and mixtures thereof.

9. The vinyl ester latex of claim 8, wherein the structural units of monoethylenically unsaturated vinyl alkanoate having 4 to 12 carbon atoms are structural units of vinyl acetate.

10. The vinyl ester latex of claim 9, wherein the structural units of monoethylenically unsaturated carboxylic acid functionalized vinyl ester having 4 to 12 carbon atoms are structural units of 6-oxo-6-(vinyloxy) hexanoic acid; and wherein the other monoethylenically unsaturated monomer is selected from the group consisting of vinyl sulfonic acid, a salt of vinyl sulfonic acid and mixtures thereof.
